(19) United States
(12) Patent Application Publication
(10) Pub. No.: US 2024/0153377 A1
(43) Pub. Date: May 9, 2024

(54) METHOD AND UNIT FOR SECURING THE CONTENT OF OBJECT DATA FOR COLLECTIVE PERCEPTION

(71) Applicant: Continental Automotive Technologies GmbH, Hannover (DE)

(72) Inventors: Sebastian Strunck, Niedernhausen (DE); Marc Menzel, Weimar (DE)

(73) Assignee: Continental Automotive Technologies GmbH, Hannover (DE)

(21) Appl. No.: 18/548,698

(22) PCT Filed: Feb. 15, 2022
(86) PCT No.: PCT/DE2022/200019

§ 371 Date: Sep. 1, 2023

(30) Foreign Application Priority Data
Mar. 1, 2021 (DE) 10 2021 201 910.2

(51) Int. Cl. G08G 1/01; H04W 4/46

(52) U.S. Cl. CPC G08G 1/0116; H04W 4/46

(57) ABSTRACT

A method for protecting the content of data for collective perception and execution by an electronic control apparatus of a first road user including capturing object data, received by means of vehicle-to-X communication, for describing an object detected by at least one capture device of a second road user and/or at least one capture device of an infrastructure device, and checking a plausibility of a state of the object described by the received object data using map information and/or sensor information, wherein the sensor information is determined using sensors of the first road user.

### CROSS-REFERENCE TO RELATED APPLICATIONS

The present application is a National Stage Application under 35 U.S.C. § 371 of International Patent Application No. PCT/DE2022/200019 filed on Feb. 15, 2022, and claims priority from German Patent Application No. 10 2021 201 910.2 filed in the German Patent and Trade Mark Office, the disclosures of which are herein incorporated by reference in their entireties.

### BACKGROUND

### 1. Field

Embodiments of the present application relate to a method and an apparatus for protecting the content of object data for collective perception.

### 2. Description of Related Art

With regard to the distribution of object data, captured using sensors, for describing detected objects by means of vehicle-to-X communication, also known under the term of collective perception, the protection is currently primarily aimed at the quality of the individual data.

### 2. Description of Related Art

WO 2014/033 172 A1 relates to a method for performing a safety function of a vehicle, in which a communication system is used to transmit data needed to perform the safety function to a control unit of the vehicle, wherein control signals are generated on the basis of the transmitted data and are transmitted to a functional unit of the vehicle by means of the control unit. The safety function is performed by means of the functional unit on the basis of the control signals, wherein diagnostic tests are carried out repeatedly at intervals of time. The diagnostic tests are used to check whether there is a fault in one or more electrical, electronic and/or programmable systems used to carry out the method, which can impair the performance of the safety function. Metadata of the data are also transmitted to the control unit by means of the communication system, wherein the metadata contain information about the systems used to carry out the method. Using this information, the control unit determines a reliability value for the data, which depends on the probability of the occurrence of errors or faults that can impair the performance of the safety function and the probability of the occurrence of these errors or faults being detected by means of the diagnostic tests and/or by a driver of the vehicle in good time before the safety function is impaired. Depending on the reliability value, the control unit also checks whether the transmitted data are sufficiently reliable for performing the safety function. However, it is basically assumed here that a data collector must ensure the truthfulness of the data.

The disadvantage of this is that safety-critical traffic situations can be triggered if the integrity of the data is not given, for example due to intentional manipulation.

Aspects and objects of embodiments of the present application may provide functional safety in collective perception using vehicle-to-X communication.

### SUMMARY

According to an aspect of an embodiment, there is provided a method for protecting the content of object data for collective perception and execution by an electronic control apparatus of a first road user, including: capturing object data, received by means of vehicle-to-X communication, for describing an object detected by at least one capture device of a second road user and/or at least one capture device of an infrastructure device, checking a plausibility of a state of the object described by the received object data using map information and/or sensor information, wherein the sensor information is determined using sensors of the first road user.

The underlying idea is that a first road user verifies object data for describing an object detected by a capture device of a second road user and/or an infrastructure device using additional sources. In this case, the object data are transmitted by the second road user and/or the infrastructure device, in particular by way of vehicle-to-X communication, and are received by the first road user. The verification makes it possible to protect the content of data for collective perception and to achieve functional safety in the case of object data, obtained by means of vehicle-to-X communication, for describing objects detected by at least one capture device of a second road user and/or at least one capture device of an infrastructure device. An object can in particular represent a road user or some other obstacle. In principle, the sensor information captured by means of the sensors can also be provided by a device for capturing an environmental model of the first road user.

The position and/or speed and/or direction of travel and/or trajectory of the object, for example, come(s) into consideration as the state of the object. The trajectory includes in particular a temporally preceding course of movement and/or a current course of movement and/or a predicted course of movement of the object. A plausibility check can thus also include a historical and/or current and/or a predicted trajectory of the object. Continuous tracking and plausibility checking of a respective object are thus made possible.

Information relating to the state of the object can be provided by the second road user and/or the infrastructure device in accordance with at least one development. Alternatively or in addition, the state is captured using the sensor information captured by the first road user. As a result, the plausibility of the state of the object can be checked using sensor information from the first road user.

A road user is, for example, a vehicle, a pedestrian, a cyclist or any other entity participating in traffic. A vehicle may be a motor vehicle, in particular a passenger vehicle, a truck, a motorcycle, an electric vehicle or a hybrid vehicle, a watercraft or an aircraft.

According to at least one embodiment, the plausibility is checked on the basis of a comparison of a state of an object described by the object data and the map information, and/or the plausibility is checked on the basis of a comparison of a state of an object described by the object data using sensor information captured using sensors of the first road user. A probability of the state relating to the object can also be checked during the plausibility check. For example, within the framework of the plausibility check, it can be regarded as improbable or implausible if the position of a traffic object classified as a vehicle is in a building or a traffic object classified as a truck is on a narrow footpath. The scope of the plausibility check can depend in particular on the available computing resources of the electronic control unit.

In addition to the plausibility check regarding the captured object, this makes it possible to detect and, if necessary, correct errors in the determined position and orientation of the second road user, which result from inaccurate position capture and orientation capture by the second road user that has captured the object in question.

According to a development, an assignment check is carried out during the plausibility check of a state of the object described by the object data using sensor information captured using sensors of the first road user, wherein the object described by the object data is intended to be assigned to an object described by the sensor information. The assignment takes place in particular when object identity is recognized. For example, the comparison is carried out using an (auto-)correlation method or another comparison method.

According to a development, the map information is at least partially received by an infrastructure device and/or the second road user and/or another road user by means of vehicle-to-X communication. As an alternative or in addition, the map information is at least partially stored in a data memory included in the first road user.

The received object data can already comprise classification information for classifying the captured object. The classification can identify the object, for example, as a vehicle or pedestrian or obstacle, wherein the classification is carried out in particular by the capture device of the second road user or of the infrastructure device that captures the object. For example, if a vehicle captures a pedestrian using sensors, it is accordingly classified as a pedestrian and the object data relating to the pedestrian are transmitted with the classification information by means of vehicle-to-X communication for reception by the first road user.

According to a development, the plausibility of the state of the object described by the object data is checked using the classification information for describing a classification type of the object. The classification information is in particular included in the received object data and/or determined by the first road user, for example using sensors of the first road user, and/or included in further received vehicle-to-X information. Examples of classification types of the object are vehicle, pedestrian, cyclist, fixed obstacle, and/or more detailed distinctions.

According to a development, the received object data are included in a collective perception message (CPM), in particular in accordance with ETSI TS 103 324. The CPM can thus be used for functions with an ASIL classification (“Automotive Safety Integrity Level”) of higher than QM.

Provision can also be made for the first road user to receive information from the second road user and/or the infrastructure device for determining at least one capture range of the object-detecting sensor system of the second road user and/or the infrastructure device. If, for example, an object cannot be detected, even though it should actually still be detectable within the capture range of the sensor system of the second road user and/or the infrastructure device according to a movement prediction, it is either searched for in the larger environment and/or the movement prediction for the object is corrected according to at least one embodiment.

In particular, an object is classified as not being able to be checked for plausibility if the object is located outside the capture range of the sensor system, taking into account an accuracy with which a movement of the object is predicted.

According to a development, combinations of the state and classified object which are not possible and/or which have a probability of occurrence equal to or below a limit value, in particular taking into account other factors, are classified as implausible in the plausibility check. For example, these can be: A motorcycle with ESC intervention, a pedestrian with ABS intervention, a bicycle with airbag deployment.

According to a development, a positioning variance and/or an orientation variance of the capture accuracy by the second road user and/or a positioning variance and/or an orientation variance of the second road user as such is/are used as an abort criterion in the comparison. According to at least one embodiment, the object data comprise confidence information for describing the accuracy with which the object data are captured. The positioning variance and/or the orientation variance can accordingly be included in the received object data and/or is/are determined during the capture using the sensors of the first road user.

Provision is expediently made for minimizing or optimizing a number of objects of a fused environmental model, which are used for the comparison, such that the creation of new objects as a result of the fusion does not lead to a worsening of the comparison, for example the (auto-)correlation. This makes it possible to avoid errors in the comparison, in particular as a result of position deviations of position information exchanged by means of V2X and objects of the environmental model and the double capture of the same object possibly resulting therefrom.

According to a development, object data relating to objects that cannot be checked for plausibility or objects classified as implausible and/or object data that cannot be checked for plausibility are discarded and/or corrected. If it is determined during the plausibility check that only the object classification is incorrect, the classification can thus be corrected. For example, pedestrians are usually not able to move at a speed of 50 km/h and trucks cannot change direction as quickly as pedestrians, with the result that the classification can be corrected on the basis of the available state information.

According to at least one embodiment, information relating to the second road user and/or the infrastructure device is captured, wherein this information is received via a further communication path which is different from the communication path of the received object data. Mobile radio communication, for example, is a further communication path.

According to a development, an identifier for identifying a transmitter of the received object data is captured as information relating to the second road user and/or the infrastructure device, wherein the identifier is received on the further communication path.

According to at least one embodiment, the receipt of the information relating to the second road user and/or the infrastructure device is preceded by a transmission of at least one request for the provision of the information relating to the second road user and/or the infrastructure device by the first road user.

According to a development, the identifier is at least partially designed in a changeable manner, such that changed information can be assigned to the identifier after a certain period of time. In particular, the identifier is a V2X pseudonym for anonymizing data communication in vehicle-to-X communication, which is changed after a defined time, e.g. 10 minutes. Alternatively or in addition, the identifier is at least partially designed in an unchangeable manner, e.g sensor setup and/or position. This makes it more difficult for an unauthorized third party to transmit messages containing incorrect information.

An advantage resulting from this is that the received object data or the content of a received V2X message can be assigned to the actual transmitter at least with greater probability. As a result, the received object data could be assigned higher confidence values for describing a trustworthiness of the information, since this makes it easier to detect, for example, manipulations of object data by a transmitter different from the actual originator of the object data.

According to a development, the further communication path also has an information source which is separate from the second road user and/or the infrastructure device and determines information relating to the second road user and/or the infrastructure device and/or the identifier of the second road user and/or the infrastructure device and makes it available to the first road user.

For example, when information is received via a further communication path, the assignment of the actual transmitter can be designed in such a way that the first road user requests infrastructure-based V2X transmitters in the environment via mobile radio and/or receives a list of transaction numbers (TANs) that are used next by the respective transmitters in the environment, e.g. at a range of 200 m, and/or the list is buffered by the vehicle and the V2X messages received in the future must contain this TAN. If a TAN is used several times, it can in turn be intercepted and copied. A one-time use of a TAN can therefore be regarded as appropriate.

For example, the V2X message can first be stored in a validation queue or it is already being processed, but with the proviso that it is subsequently discarded. This can overcome problems due to transmission latency in polling.

According to a second aspect, the disclosure describes an electronic control apparatus to be carried by a first road user, comprising a computing device for capturing object data, received by means of vehicle-to-X communication, for describing an object detected by at least one capture device of a second road user and/or at least one capture device of an infrastructure device, and to check the plausibility of a state of the object described by the received object data using map information and/or sensor information, wherein the sensor information is determined using sensors of the first road user. Depending on the road user, it can be carried, in particular in the case of a vehicle, by being installed in the first road user or, for example in the case of a pedestrian, by being carried along.

According to a further aspect of an embodiment, the apparatus is configured to carry out a method according to at least one of the described embodiments.

A computing device may be any device that is designed to process at least one of said signals. In particular, the computing device may be a processor, for example an ASIC, an FPGA, a digital signal processor, a central processing unit (CPU), a multi-purpose processor (MPP) or the like.

In one development of the specified apparatus, the specified apparatus has a memory. In this case, the specified method is stored in the memory in the form of a computer program, and the computing device is provided for carrying out the method when the computer program is loaded into the computing device from the memory.

According to a further aspect of an embodiment, a computer program comprises program code means in order to perform all the steps of one of the specified methods when the computer program is executed on a computer or one of the specified apparatuses.

According to a further aspect of an embodiment, a computer program product contains a program code that is stored on a computer-readable data carrier and that, when executed on a data processing device, performs one of the specified methods.

### BRIEF DESCRIPTION OF THE DRAWINGS

Other features of the present application are described with reference to the drawings, in which:

FIG. 1 is a flowchart of a method protecting content of object data, according to an embodiment; and

FIG. 2 is a diagram of an electronic control apparatus according to an embodiment.

### DETAILED DESCRIPTION

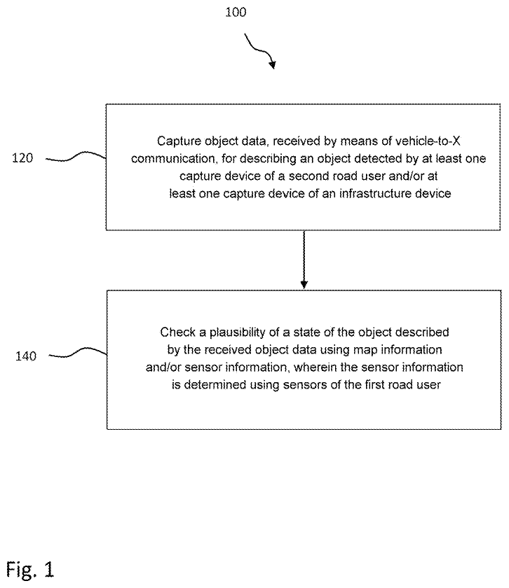

FIG. 1 shows, in the form of a flowchart, an exemplary method 100 for protecting the content of data for collective perception and execution by an electronic control apparatus of a first road user according to one embodiment of the disclosure. In a step 120, object data, received by means of vehicle-to-X communication, for describing an object detected by at least one capture device of a second road user and/or at least one capture device of an infrastructure device are captured. In a step 140, a plausibility of a state of the object described by the received object data is checked using map information and/or sensor information, wherein the sensor information is determined using sensors of the first road user.

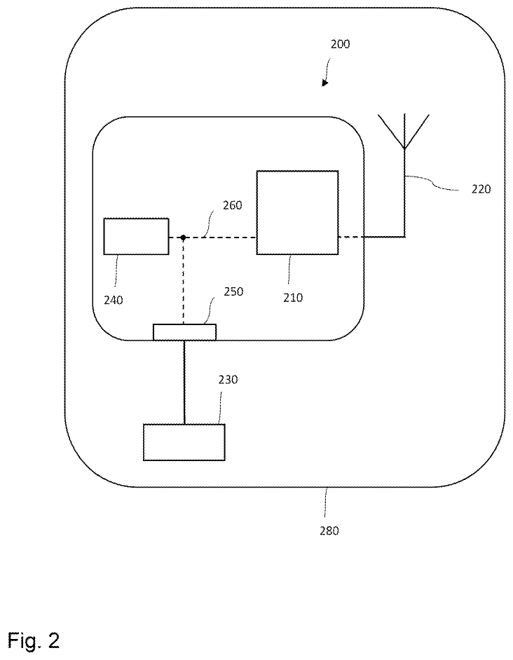

FIG. 2 shows a schematic illustration of an exemplary embodiment of the electronic control apparatus 200 to be carried by a first road user 280, comprising a computing device 210 for capturing object data, received by means of vehicle-to-X communication, for describing an object detected by at least one capture device of a second road user and/or at least one capture device of an infrastructure device, and to check the plausibility of a state of the object described by the received object data using map information and/or sensor information, wherein the sensor information is determined using at least one sensor 230 of the first road user 280. According to a development, the map information can be stored in a data memory 240 included in the first road user 280 and/or in the electronic control apparatus 200, wherein provision may be made for the computing device 210 to be able to access the map information via a communication means 260. The electronic control apparatus 200 or the computing device 210 can be configured to receive the sensor information from the sensor 230 via a communication interface 250, for example a data bus interface.

According to at least one exemplary embodiment, the electronic control apparatus 200 comprises an antenna 220 for vehicle-to-X communication, which is connected to the computing device for transmitting received vehicle-to-X messages and/or vehicle-to-X messages to be transmitted. Further components, for example relating to vehicle-to-X communication, such as receivers, compensators, etc., which are usually used in wireless transmission technology, were not illustrated solely for the sake of clarity.

If it is found in the course of the proceedings that a feature or a group of features is not absolutely necessary, then the applicant aspires right now to a wording of at least one independent claim that no longer has the feature or the group of features. This may be, for example, a subcombination of a claim present on the filing date or a subcombination of a claim present on the filing date that is restricted by further features. Claims or combinations of features of this kind requiring rewording are intended to be understood as also covered by the disclosure of this application.

It should also be pointed out that refinements, features and variants of the embodiment which are described in the various embodiments or exemplary embodiments and/or shown in the figures may be combined with one another in any desired manner. Single or multiple features are interchangeable with one another in any desired manner. Combinations of features arising therefrom are intended to be understood as also covered by the disclosure of this application.

Back-references in dependent claims are not intended to be understood as a relinquishment of the attainment of independent substantive protection for the features of the back-referenced dependent claims. These features may also be combined with other features in any desired manner.

Features which are only disclosed in the description or features which are only disclosed in the description or in a claim in conjunction with other features may in principle be of independent significance essential to the embodiment. They may therefore also be individually included in claims for the purpose of delimitation from the prior art.

In general, it should be pointed out that vehicle-to-X communication is understood to mean in particular a direct communication between vehicles and/or between vehicles and infrastructure devices. For example, it may thus include vehicle-to-vehicle communication or vehicle-to-infrastructure communication. Where this application refers to a communication between vehicles, said communication may fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication may be implemented using the IEEE 802.11p or IEEE 1609.4 standard. A vehicle-to-X communication may also be referred to as C2X communication or V2X communication. The sub-domains may be referred to as C2C (car-to-car), V2V (vehicle-to-vehicle) or C2I (car-to-infrastructure), V2I (vehicle-to-infrastructure). However, the embodiment explicitly does not exclude vehicle-to-X communication with switching via a mobile radio network, for example.

1. A method (100) for protecting the content of object data for collective perception and execution by an electronic control apparatus of a first road user, comprising the steps of:
capturing (120) object data, received by means of vehicle-to-X communication, for describing an object detected by at least one capture device of a second road user and/or at least one capture device of an infrastructure device,
checking (140) a plausibility of a state of the object described by the received object data using map information and/or sensor information, wherein the sensor information is determined using sensors of the first road user.

2. The method as claimed in claim 1, wherein the state of the object is its position and/or speed and/or direction of travel and/or trajectory, wherein the trajectory describes a temporally preceding course of movement and/or a current course of movement and/or a predicted course of movement of the object.

3. The method as claimed in at least one of the preceding claims, wherein the received object data are included in a collective perception message.

4. The method as claimed in at least one of the preceding claims, wherein the object data comprise classification information for describing a classification type of the detected object, and the plausibility of the state of the object described by the object data is checked using the classification information for describing a classification type of the object.

5. The method as claimed in claim 4, wherein combinations of the state of the object and the classification of the object which are not possible and/or which have a probability of occurrence equal to or below a limit value are classified as implausible in the plausibility check.

6. The method as claimed in at least one of the preceding claims, wherein the plausibility is checked on the basis of a comparison of the state of the object described by the received object data and the map information and/or on the basis of a comparison of the state of the object described by the received object data with the sensor information captured using the sensors of the first road user.

7. The method as claimed in the preceding claim, wherein a positioning variance and/or an orientation variance of the accuracy with which the object is captured by the second road user and/or a positioning variance and/or an orientation variance of the second road user as such is/are used as an abort criterion for the comparison.

8. The method as claimed in at least one of the preceding claims, wherein an object classified as implausible and/or object data which cannot be checked for plausibility is/are discarded and/or corrected.

9. The method as claimed in at least one of the preceding claims, wherein information relating to the second road user and/or the infrastructure device is captured, wherein this information is received via a further communication path which is different from the communication path of the received object data.

10. The method as claimed in claim 9, wherein at least one identifier for identifying a transmitter of the received object data is captured as information relating to the second road user and/or the infrastructure device, wherein the identifier is received on the further communication path.

11. An electronic control apparatus (200) to be carried by a first road user (280), comprising a computing device (210) for capturing object data, received by means of vehicle-to-X communication, for describing an object detected by at least one capture device of a second road user and/or at least one capture device of an infrastructure device, wherein the computing device (210) is further configured to check the plausibility of a state of the object described by the received object data using map information and/or sensor information, wherein the sensor information is determined using at least one sensor (230) of the first road user (280).

12. An electronic control apparatus (200) configured to carry out a method as claimed in at least one of claims 1 to 10.

13. The use of the electronic control apparatus (200) as claimed in either of the preceding claims 11 and 12 in a vehicle (280).
